(19) United States
(12) Patent Application Publication
(10) Pub. No.: US 2026/0303133 A1
(43) Pub. Date: Oct. 1, 2026

(54) SYSTEM AND DESIGN METHOD OF INTEGRATED MACRO GNODEB WITH CARRIER AGGREGATION

(71) Applicant: JIO PLATFORMS LIMITED, Ahmedabad (IN)

(72) Inventors: Pradeep Kumar BHATNAGAR, Navi Mumbai (IN); Deepak GUPTA, Navi Mumbai (IN); Nekiram KHOSYA, Dombivali East (IN); Renuka R, Dombivali East (IN); Amrish BANSAL, Navi Mumbai (IN); Aayush BHATNAGAR, Navi Mumbai (IN)

(73) Assignee: JIO PLATFORMS LIMITED, Ahmedabad (IN)

(21) Appl. No.: 18/881,904

(22) PCT Filed: Oct. 30, 2023
(86) PCT No.: PCT/IB2023/060913

§ 371 Date: Jan. 8, 2025

(30) Foreign Application Priority Data
Oct. 31, 2022 (IN) 202221061800

(51) Int. Cl. H04B 1/04; H04L 5/00

(52) U.S. Cl. CPC H04B 1/0475; H04L 5/001; H04L 5/0023; H04L 5/0048; H04L 5/0055; H04B 2001/045

(57) ABSTRACT

The present disclosure generally relates to a base station comprising an integrated baseband and transceiver board (IBTB) includes one or more network processors, and one or more transceiver, wherein the IBTB, at the one or more network processors, receives, from a backhaul, external input Direct Current (DC) voltage and down converts said received input DC voltage using an isolated power supply to generate one or more control signals. The base station includes a Radio Frequency (RF) front end board (RFEB) that receives and processes the one or more control signals using RF transmit chains for signal transmission, RF receive chains for signal reception, and RF observation chains that act as feedback paths from power amplifier(s) of the RF transmit and receive chains to the transceiver for linearization. The base station includes a cavity filter to provide steeper roll-off outside operating band.

### FIELD OF INVENTION

Embodiments of the present disclosure generally relate to wireless telecommunication networks. More particularly, the present disclosure relates to systems and design methods for implementing an integrated macro radio base station with carrier aggregation.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Base stations and mobile devices operating in a cellular network may exchange data. Various techniques may be used to improve capacity and/or performance, in some cases, including communication in accordance with new radio (NR) techniques.

In the Universal Mobile Telecommunications System (UMTS) network, specifications of long-term evolution (LTE) have been drafted for the purpose of further increasing high speed data rates, providing lower delays, or the like. In addition, LTE-Advanced has been standardized for the purpose of achieving increased capacity and enhancement beyond LTE. LTE successor systems are also under study.

5G New Radio (NR) Next-Generation Node B (gNB) massive multiple-input multiple-output (MIMO) may provide good coverage and capacity for dense urban clutter of high-rise buildings because of eight pencil beams in downlink and four pencil beams in uplink under multi User Equipment (UE) cases. However, outdoor small cell solutions may provide capacity boost at hotspot locations where traffic demand is significantly high and which may not be served by gNB alone. In lower density areas with widespread or scattered population, on the other hand, there are major issues of accessibility. They ought to have high coverage and limited capacity as an ideal solution. FIG. 1 shows the current architecture (100) having a baseband unit at bottom tower supporting 3 cells of 700 MHz Radio Unit and 3 cells of 3.5 GHz 32 TR Massive MIMO Radio Unit (MRU) on Open Radio Access Network (ORAN). Existing solutions are configured in a manner such that, for instance, a 700 MHz and 3.5G MRU (Decentralized Unit (DU)-Centralized Unit (CU) Server, fronthaul) are separately connected with the cell site router via 10G ORAN and 25G ORAN respectively, the broadband units and a backhaul, which makes the system more costly and complicated.

There is, therefore, a need for solutions and devices that may be beneficial to provide coverage and capacity as per MRU because of four pencil beams in downlink and two pencil beams in uplink beams, thus making it a hybrid solution for Rural and Sub-Urban areas to meet the coverage and limited capacity requirements. There is further a need for a device/solution that provides cost and energy-efficient solution to any network leading to operational expenditure (OPEX) benefits. There is further a need for a device/solution where carrier aggregation and ORAN functionality may be merged in the 3.5 GHz radio (macro unit) and that may overcome the shortcomings of the existing prior art(s).

### OBJECTS OF THE PRESENT DISCLOSURE

Some of the objects of the present disclosure, which at least one embodiment herein satisfies are as listed herein below.

An object of the present disclosure is to provide solutions and devices that are beneficial to provide coverage and capacity as per Massive multiple-input multiple-output (MIMO) Radio Unit (MRU).

An object of the present disclosure is to provide a hybrid solution for Rural and Sub-Urban areas to meet the coverage and limited capacity requirements.

An object of the present disclosure is to provide a device/solution that provides cost and energy-efficient solution to any network leading to operational expenditure (OPEX) benefits.

An object of the present disclosure is to provide a device/solution where carrier aggregation and Open Radio Access Network (ORAN) functionality may be merged in the 3.5 GHz radio (macro unit).

An object of the present disclosure is to provide a 5G Integrated Macro Next-Generation Node B (gNB) with Carrier Aggregation (CA) of 700 MHz bands that provides an overall hardware overview of Macro gNB design for standalone mode, and is configured as an “All-in-one” unit having at least one of a baseband unit, a Radio Frequency (RF) unit, and an antenna unit in a single enclosure for easy and efficient installation.

An object of the present disclosure is to provide a 5G Integrated Macro gNB with 700 MHz CA on ORAN-based fronthaul interface that eliminates requirement for Centralized Unit (CU) and Distributed Unit (DU).

An object of the present disclosure is to provide a 5G Integrated Macro gNB that enables direct connection of about 700 Radio Units (RUs) to Macro gNB over ORAN interface, and named as Integrated Macro gNB with CA of 700 MHz.

An object of the present disclosure is to provide a 5G Integrated Macro gNB with CA of 700 MHz that renders an “All-in-one” class design having a Physical (PHY) layer, a Medium Access Control (MAC) layer, and an Application layer along with complete mechanical housing in one box.

Another object of the present disclosure is to provide an overall integrated system having a network processor and one or more transceivers on a board with 22 or more layers.

Yet another object of the present disclosure is to provide a multilayer substrate for high power amplifier to accommodate complex RF and digital signal routing in RF Front End Board.

Yet another object of the present disclosure is to provide clock synchronization architecture using system synchronizer Integrated Circuit (IC) and clock generators.

Yet another object of the present disclosure is to facilitate L1 layer development and bit stream generation in Application Specific Integrated Circuit (ASIC) transceiver, and enable blind mated and cable less design.

Yet another object of the present disclosure is to facilitate power efficiency with overall power consumption of about 714 W to significantly improve OPEX.

Yet another object of the present disclosure is to provide a unique power supply design of converting external inputs of 48V to 28V, and 28V further to 12V using isolated design with 22 or more layers, and having high speed and RF design.

Yet another object of the present disclosure is to provide a unique circuit design implementation to maintain uniform RF output across specified temperature range.

Yet another object of the present disclosure is to provide a design approach to self-heal the system from software corruption and any other unwanted failure from software faults to help minimize on-site visit of an engineer and thereby save OPEX.

Yet another object of the present disclosure is to provide a unique baseband board design for a thermally efficient system.

Yet another object of the present disclosure is to provide closed-loop monitoring and control of output RF power on each antenna port based on ambient temperature.

Yet another object of the present disclosure is to provide a base station that handles holdover requirements defined in telecom standards.

### SUMMARY

This section is provided to introduce certain objects and aspects of the present disclosure in a simplified form that are further described below in the detailed description. This summary is not intended to identify the key features or the scope of the claimed subject matter.

Embodiments pertain to wireless communications. Some embodiments relate to wireless networks including Third Generation Partnership Project (3GPP) networks, 3GPP Long Term Evolution (LTE) networks, and 3GPP LTE-A (LTE Advanced) networks. Some embodiments relate to Fifth Generation (5G) networks. Some embodiments relate to New Radio (NR) networks.

In an aspect, the present disclosure relates to a macro base station including an integrated baseband and transceiver board (IBTB) having one or more network processors, one or more transceivers for processing Radio Frequency (RF) signals, where the IBTB, at the one or more network processors, receives, from a backhaul, external input direct current (DC) voltage and down converts said received input DC voltage using an isolated power supply to generate one or more control signals. In some embodiments, the one or more network processors may perform Layer 2 and Layer 3 processing of sub 6 GHz and 700 MHz bands. Further, the one or more transceivers may include a first transceiver and a second transceiver. The first transceiver may perform Layer 1 processing of sub 6 GHz bands and the second transceiver performs processing of a Physical (PHY) layer of 700 MHz bands.

The base station includes an RF front end board (RFEB) that receives the one or more control signals, and processes said one or more control signals using a plurality of RF receive chains for signal reception, a plurality of RF transmit chains for signal transmission, and a plurality of RF observation chains that act as feedback paths from one or more power amplifiers of the RF transmit and receive chains to the one or more transceivers for linearization. The proposed base station includes a cavity filter to provide steeper roll-off outside on operating band, and an interface for operating one or more antennas.

In an aspect, the base station may be a 5G integrated macro Next Generation Node B(gNB) that merges carrier aggregation (CA) and Open Radio Access Network (ORAN) functionality in a radio unit (RU), said merger allowing handling of capacity and coverage of Massive MIMO Radio Unit (MRU). The base station may provide CA of 700 MHz bands on ORAN based fronthaul interface.

In another aspect, the received external input DC voltage is 48V, which may be down-converted to 28V, and further down-converted to 12V simultaneously.

In yet another aspect, the IBTB may include a power management integrated chipset (PMIC), a DC-DC converter, and a Low Drop Out (LDO) regulator to generate voltages based on requirements of components forming part of the IBTB. In another exemplary aspect, the IBTB may include at least one temperature sensor to evaluate thermal profile of the board and facilitate taking of a decision in case of a thermal failure.

In another aspect, the one or more transceivers may be configured to monitor an output of the one or more power amplifiers by measuring received power on Analog-to-Digital Converter (ADC) while utilizing a feedback chain, said measured power being utilized for monitoring total transmit power in closed loop.

In an aspect, the base station may include a synchronization circuit for synchronization of components in the IBTB, wherein the synchronization circuit may include at least one of an ultra-low noise clock generation Phase-Locked Loop (PLLs), programmable oscillator, and a system synchronizer.

In another aspect, the IBTB may include a plurality of sub-systems selected from any or a combination of a digital high-speed signal sub-system, a switching power supply sub-system, and a clock section, and an RF signal sub-system. The IBTB may be configured as a Printed Circuit Board (PCB) with 22 or more layers, said PCB design including a mechanism to route RF signals and Peripheral Component Interconnect Express (PCIe) signals running on adjacent layers.

In yet another aspect, the RFEB may be configured to receive the one or more control signals from the IBTB along with a power supply through a connector, wherein 4 transmit chains may be configured for signal transmission, 4 receive chains may be configured for signal reception, and 4 observation chains may be configured to act as Digital Pre-Distortion (DPD) feedback paths from the one or more power amplifiers to an Application Specific Integrated Circuit (ASIC) transceiver from the one or more transceivers for linearization.

In another aspect, each transmit chain may be configured to carry matching a Balun, a Pre-Driver amplifier and final RF power amplifier as final stage power amplifier, whereas each receive chain may be configured to carry low noise amplifier band passes Surface Acoustic Wave (SAW) filter and a matching network. Each observation chain may be configured to carry a directional coupler, a digital step attenuator (DSA), and a matching network, wherein the RFEB may include RF switch that may combine each transmit-receive pair. In another aspect, a circulator and cavity filter may be used between each RF switch to antenna port.

In an aspect, the RFEB may be configured to blind mate with the IBTB and the cavity filter, where one or more mating bullets provide connection between the IBTB and the RFEB to facilitate provision of at least up to about 200 W output.

In an aspect, the cavity filter may be a 4-port cavity filter for a 4-transmit-4-receive (4T4R) configuration. In an aspect, a method for operating a base station

In an aspect, a method for operating a base station includes providing a base station having an integrated baseband and transceiver board (IBTB) with one or more network processors and one or more transceivers for processing Radio Frequency (RF) signals. The method includes receiving, at the one or more network processors, an external input direct current (DC) voltage from a backhaul and down-converting the received input DC voltage using an isolated power supply to generate one or more control signals. The method includes processing, at an RF front end board (RFEB), the one or more control signals using a plurality of RF receive chains for signal reception, a plurality of RF transmit chains for signal transmission, and a plurality of RF observation chains that act as feedback paths from one or more power amplifiers of the RF transmit and receive chains to the one or more transceivers for linearization. The method includes providing, by a cavity filter, a steeper roll-off outside operating band, the cavity filter operably interacts with one or more antennas via an interface.

In an aspect, for processing RF signals, the method may include performing, by the one or more network processors, Layer 2 and Layer 3 processing of sub 6 GHz and 700 MHz bands. The method may include performing, by the one or more transceivers, Layer 1 processing of sub 6 GHz bands, and processing, by the one or more transceivers, Physical (PHY) layer of 700 MHz bands.

In an aspect, the present disclosure provides a user equipment (UE) communicatively coupled with a base station. The coupling may include the steps of receiving a connection request, sending an acknowledgment of the connection request to the base station, and transmitting a plurality of signals in response to the connection request.

In an aspect, the present disclosure provides a non-transitory computer-readable medium including processor-executable instructions that cause a processor to provide a base station having an integrated baseband and transceiver board (IBTB) with one or more network processors and one or more transceivers for processing Radio Frequency (RF) signals, receive, at the one or more network processors, an external input direct current (DC) voltage from a backhaul and down convert the received input DC voltage using an isolated power supply to generate one or more control signals, process, at an RF front end board (RFEB), the one or more control signals using a plurality of RF receive chains for signal reception, a plurality of RF transmit chains for signal transmission, and a plurality of RF observation chains that act as feedback paths from one or more power amplifiers of the RF transmit and receive chains to the one or more transceivers for linearization; and provide, by a cavity filter, a steeper roll-off outside operating band, the cavity filter operably interacts with one or more antennas via an interface.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an existing telecom network architecture (100).

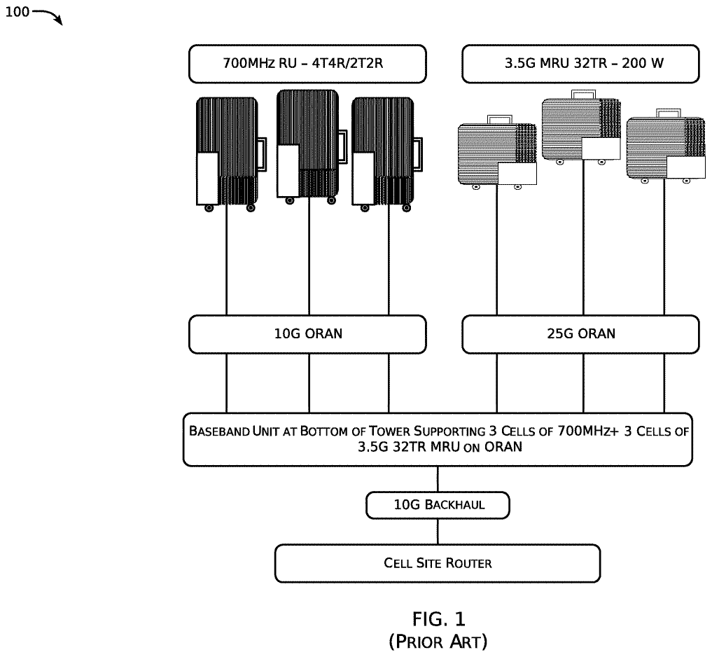

FIG. 2 illustrates an exemplary proposed network architecture (200), in accordance with embodiments of the present disclosure.

FIG. 3 illustrates an exemplary high level block diagram (300) for 200 W integrated macro Next-Generation Node B (gNB) (302) with 700 MHz upper Physical (PHY) Layer Carrier Aggregation (CA) and lower PHY on 700 MHz Radio Unit (RU), in accordance with embodiments of the present disclosure.

FIG. 4 illustrates an exemplary high-level architecture (400) of 4-transmit-4-receive (4T4R) 5G New Radio (NR) Integrated Macro gNB (302) with CA of 700 MHz, in accordance with embodiments of the present disclosure.

FIG. 5 illustrates an exemplary high-level architecture (500) of the Integrated Baseband and Transceiver Board (IBTB) (402) forming part of the proposed base station, in accordance with embodiments of the present disclosure.

FIG. 6 illustrates an exemplary high-level block diagram (600) of a synchronization circuit (510) of the IBTB (402), in accordance with embodiments of the present disclosure.

FIG. 7 illustrates an exemplary block diagram (700) of a single chain of 4T4R Radio Frequency (RF) Front End Board (RFEB) (404), in accordance with embodiments of the present disclosure.

FIG. 8 illustrates an exemplary flowchart (800) for operating a base station, in accordance with embodiments of the present disclosure.

FIG. 9 illustrates an exemplary computer system (900) in which or with which embodiments of the present disclosure may be implemented.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter may each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the present disclosure as set forth.

Certain terms and phrases have been used throughout the disclosure and will have the following meanings in the context of the ongoing disclosure.

Throughout the disclosure, “about” in reference numeric values means and includes ±10% of the reference numeric value.

The term “multiple-input multiple-output (MIMO)” may refer to a wireless technology that uses multiple transmitters and receivers to transfer more data at the same time.

The term “massive MIMO” may refer to type of wireless communications technology in which base stations are equipped with a very large number of antenna elements to improve spectral and energy efficiency.

The term “blind mate” or “blind mating” or “blind mate conditions” or “blind mate connectors” may refer to connectors in which the mating is done via a sliding or snapping action and are constructed with a self-aligning feature. Further, blind mate conditions are used where the connection area is hidden from viewing or cannot be reached for alignment. It should be understood that the terms “blind mate,” “blind mating,” “blind mate conditions,” and “blind mate connectors” are used interchangeably throughout the disclosure.

The term “4-transmit-4-receive (4T4R)” may refer to transmit and receive mode for base stations with four transmit and four receive antennas.

The term “digital pre-distortion (DPD)” may refer to a method by which one first stimulates a non-linear power amplifier with baseband samples and then observes the result of that stimulus at its output.

The term “phase-locked loop (PLL)” or “phase lock loop (PLL)” may refer to a feedback circuit designed to allow one circuit board to synchronize the phase of its on-board clock with an external timing signal.

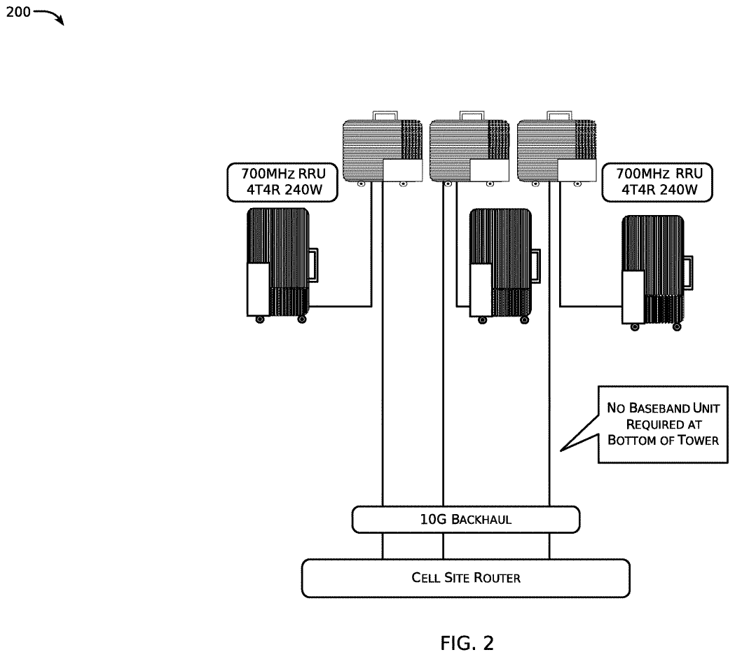

Various embodiments of the present disclosure will be explained in detail with reference to FIGS. 2-9.

FIG. 2 illustrates an exemplary proposed network architecture (200) in accordance with embodiments of the present disclosure showing a 3.5G 4-transmit-4-receive (4T4R)—200 W radio pre-integrated with 700 MHz Radio Unit at top of a tower, and no requirement being provided for one or more baseband units at bottom of the tower.

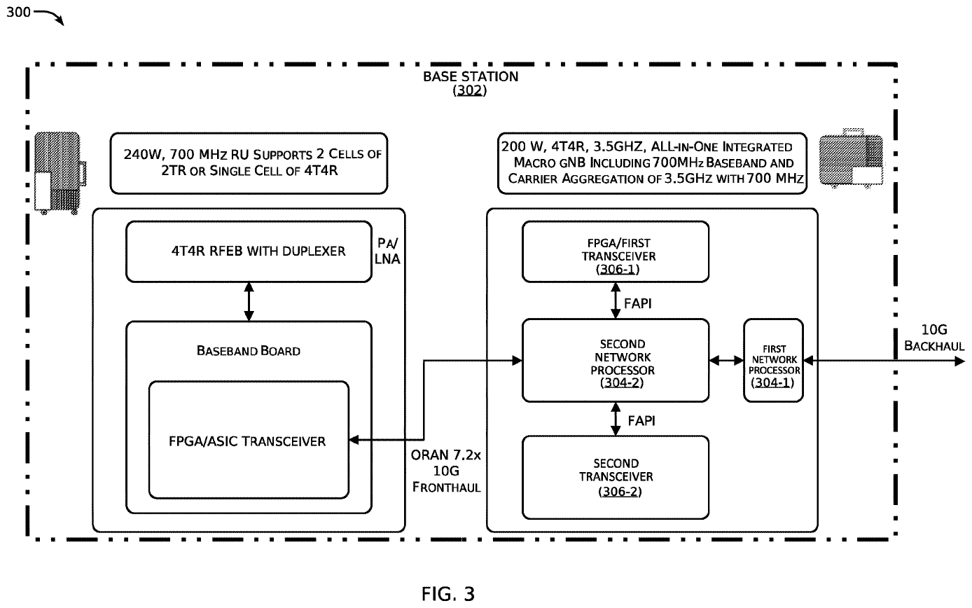

FIG. 3 illustrates an exemplary high level block diagram (300) for 200 W integrated macro Next-Generation Node B (gNBs) or base station (302) with 700 MHz upper Physical (PHY) Layer Carrier Aggregation (CA) and lower PHY on 700 MHz Radio Unit (RU), in accordance with embodiments of the present disclosure.

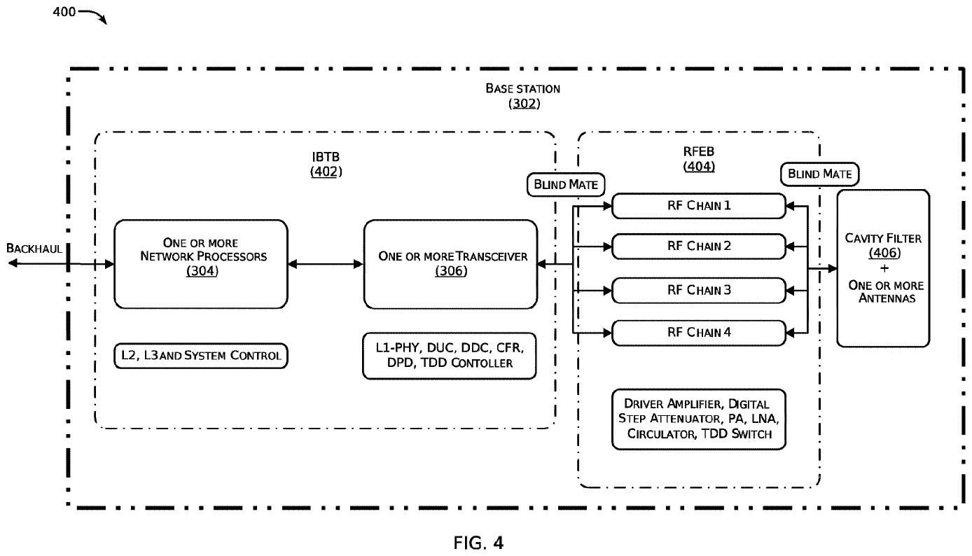

In some embodiments, gNBs may be indicative of base stations of a Fifth Generation (5G) network. As shown, the proposed base station (302) may include a 240 W, 700 MHz RU (having 4T4R Radio Frequency (RF) Front End Board (RFEB) (404) (as shown in FIG. 4) and a baseband board) that supports 2 cells of 2-transmit-2-receive (2T2R) configuration or single cell of 4T4R that is operatively coupled with a 200 W, 4T4R, 3.5 GHz, All-in-One Integrated Macro gNB (having an integrated baseband and transceiver board (IBTB) (402) and RFEB (404) as shown in FIG. 4) including 700 MHz Baseband and CA of 3.5 GHz with 700 MHz. The base station (302) may include one or more network processors (304), such as a first network processor (304-1) and a second network processor (304). Further, the base station (302) may include one or more transceivers (306), such as a Field Programmable Gate Array (FPGA)/first transceiver (306-1) and a second transceiver (306-2). The one or more transceivers (306) may receive and transmit RF signals to one or more User Equipment (UE) requesting services from a network.

In some embodiments, the UE may be communicatively coupled to the base station (302). The coupling may be through a wireless network. In an exemplary embodiment, the wireless network may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The UE may be any handheld device, mobile device, palmtop, laptop, smart phone, and the like. As a result of the coupling, the UE may be configured to receive a connection request from the base station (302), send an acknowledgment of the connection request to the base station (302), and transmit a plurality of signals in response to the connection request.

With reference to FIGS. 4-7, an exemplary high-level architecture (400) of proposed 4T4R 5G New Radio (NR) Integrated Macro gNB with CA of 700 MHz (interchangeably referred to as the base station (302)) in accordance with embodiments of the present disclosure is illustrated along with components part of the proposed base station (302). In an exemplary aspect, an antenna operatively coupled with the proposed base station (302) may be an external base station antenna. The one or more antennas may be connected to the base station (302) with one or more jumper RF cables. The one or more antennas may allow the base station (302) to receive and transmit RF signals from and to one or more UEs.

In an aspect, the present disclosure provides a macro base station device (302) including the IBTB (402) having the one or more network processors (304). The one or more network processors (304) may perform Layer 2 and Layer 3 processing of sub 6 GHz bands, and 700 MHz bands. The IBTB (402) may include one or more transceivers (306). Each transceiver (306) may be made of a FPGA or Application Specific Integrated Circuit (ASIC). The one or more transceivers (306) may include the first transceiver (306-1) for Layer 1 processing of sub 6 GHz bands and the second transceiver (306-2) for processing of PHY layer 700 MHz bands, thereby allowing for Carrier Aggregation of 700 MHz bands with other sub 6 GHz bands. In some embodiments, the IBTB (402) may, at the one or more network processors (304), receive, from a backhaul, an external input Direct Current (DC) voltage and down converts said received input DC voltage using an isolated power supply to generate one or more control signals. The external input DC voltage may be received from the one or more antennas, when the one or more antennas receive one or more of the RF signals from the UE.

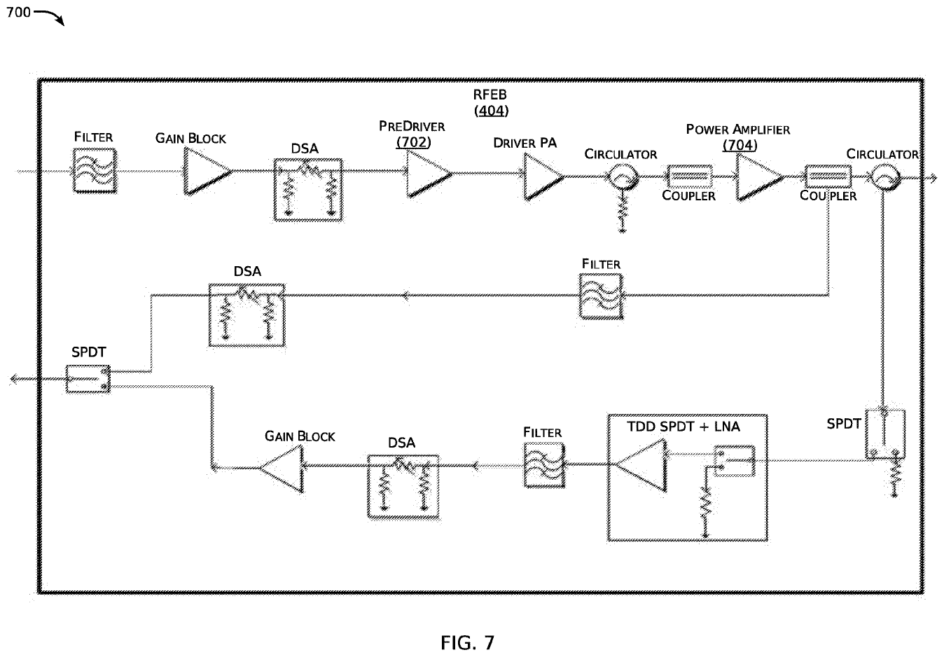

The base station (302) may further include the RFEB (404) that receives the one or more control signals, and processes said one or more control signals using a plurality of RF receive chains for signal reception, a plurality of RF transmit chains for signal transmission, and a plurality of RF observation chains that act as feedback paths from one or more power amplifiers (704) (as shown in FIG. 7) of the RF transmit and receive chains to the transceivers (306) for linearization. Each receive chain, transmit chain, and observation chain may facilitate processing and exchange of RF signals with the one or more UEs. The proposed base station (302) may include a cavity filter (406) to provide steeper roll-off outside operating band. The operating band may be a range of predetermined RF signals. The base station (302) may include an interface for operating one or more antennas. The interface may allow for conversion for RF signals to electrical signals and vice versa.

In an aspect, the base station (302) may be a 5G integrated macro gNB that merges CA and Open Radio Access Network (ORAN) functionality in a RU. The merging of said functionality allows for handling of capacity and coverage of a Massive MIMO Radio Unit (MRU). The base station (302) provides CA of 700 MHz bands on ORAN based fronthaul interface. In some embodiments, the ORAN interface may have 7.2×split option.

In another aspect, the received external input DC voltage is 48V, which is down converted to 12V. In some embodiments, the external input DC voltage may be down-converted to 28V, and subsequently further down-converted to 12V. In some embodiments, the received external input DC voltage is converted into multiple outputs.

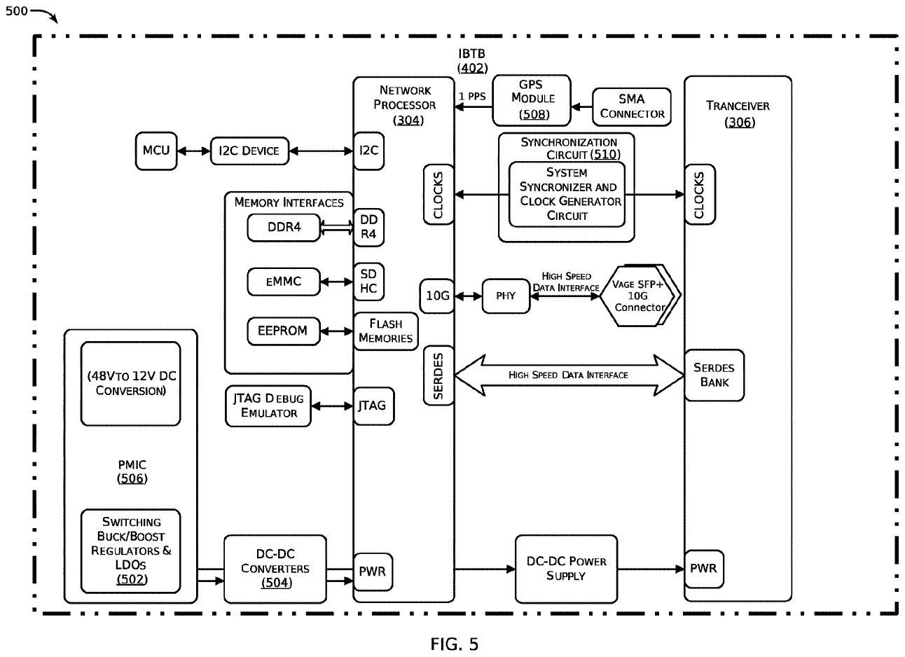

In yet another aspect, the IBTB (402) may include a power management integrated chipset (PMIC) (506), a DC-DC converter (504), and a Low Drop Out (LDO) regulator (502) to generate lower voltages based on requirements from components forming part of the IBTB (402), as shown in high-level architecture (500) of the IBTB (402) in FIG. 5. In another exemplary aspect, the IBTB (402) may include at least one temperature sensor to evaluate thermal profile of the RFEB (404) and facilitate taking of a decision in case of a thermal failure. In some embodiments, temperatures may be monitored from at least 10 sections of the IBTB (402). The IBTB (402) may be configured to, in an exemplary implementation, self-heal itself from software corruption or fault generation, thereby reducing downtimes of the base station (302). The self-healing capabilities may reduce the operational expense (OPEX) of the base station (302), and reduce need for on-site maintenance.

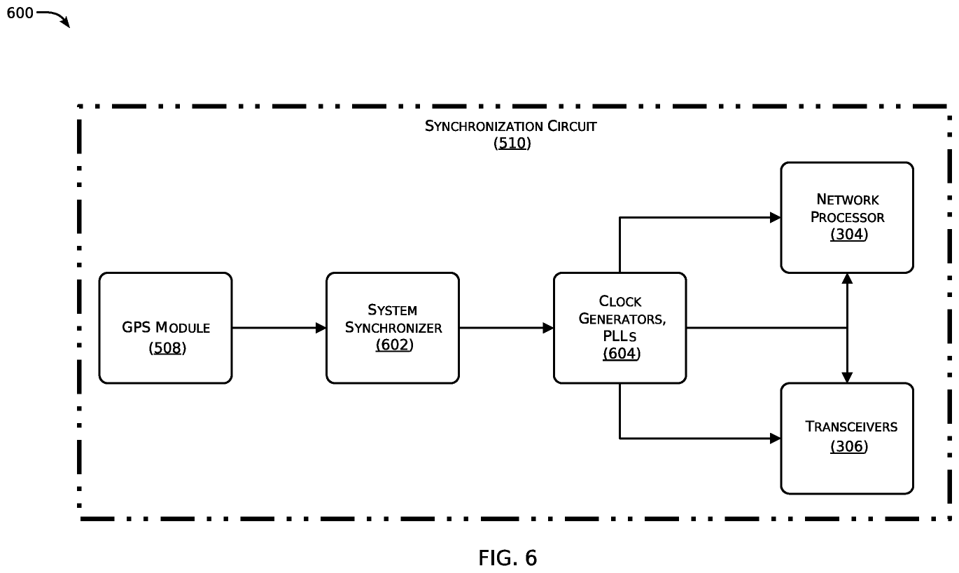

In another aspect, the transceiver (306) may be implemented on an ASIC and configured to monitor the one or more power amplifiers (704) output by measuring received power on an Analog-to-Digital Converter (ADC) while utilizing a feedback chain, said measured power being utilized for monitoring total transmit power in a closed loop. Furthermore, components of the IBTB (402) may be synchronized to external world using a clock and synchronization circuit (510), which may be configured in or operatively coupled to the IBTB (402). The synchronization circuit (510) may include at least one of, but not be limited to, an ultra-low noise clock generation PLL(s) (604), a programmable oscillator, and a system synchronizer (602), as shown in high-level block diagram (600) of the synchronization circuit (510) in FIG. 6. The synchronization circuit (510) may also include a Global Positioning System (GPS) module (506) The components of the IBTB (402) may be configured to handle holdover requirement defined in telecom standards.

In another aspect, IBTB (402) may also include any one or combination of, but not be limited to, a plurality of sub-systems selected from any or a combination of digital high speed signal sub-system, switching power supply sub-system, a clock section RF signal sub-system, and the like. The IBTB (402) may be made of a Printed Circuit Board (PCB) with 22 or more layers. The PCB may include a mechanism to route RF signals and Peripheral Component Interconnect Express (PCIe) signals running on adjacent layers to defined design specifications. In some exemplary embodiments, the PCB may be designed to route RF signals and PCIe Gen 3.0 signals running on high speed 8 GT/s on adjacent layers and meet design specifications.

In yet another aspect, the RFEB (404) may be configured to receive the one or more control signals from the IBTB (402) and a power supply through a connector, wherein 4 transmit chains may be configured for signal transmission, 4 receive chains may be configured for signal reception, and 4 observation chains may be configured to act as a Digital Pre-Distortion (DPD) feedback paths from the one or more power amplifiers (704) to the one or more transceivers (306) for linearization.

In another aspect, each transmit chain may be configured to carry matching Balun, Pre-Driver amplifier (702), and one or more of the power amplifiers (704) as final stage power amplifier, whereas each receive chain may be configured to carry low noise amplifier band pass one or more Surface Acoustic (SAW) filters and a matching network, as shown in block diagram (700) of a single chain of 4T4R RFEB (404) in FIG. 7. Each observation chain may be configured to carry a directional coupler, one or more digital step attenuators (DSAs), and a matching network, where the RFEB (404) may include RF switch that may combine each transmit-receive pair. In another aspect, a circulator and the cavity filter (406) may be used between each RF switch to an antenna port. The cavity filter (406) may be configured to operably interact with the one or more antennas via the interface.

In an aspect, RFEB (404) may be configured on a multilayer substrate that may use embedded copper coin technology for high power Gallium Nitrate (GAN) amplifier to deliver at least up to about 200 W output power thermal efficiently. Furthermore, the RFEB (404) may be configured to blind mate with IBTB (402) and the cavity filter (406). One or more mating bullets may provide connection between the IBTB (402) and the RFEB (404) to facilitate provision of at least up to about 200 W output.

In an aspect, the cavity filter (406) may be a 4-port cavity filter for providing a 4T4R configuration. The proposed base station (302) may be configured to provide and meet RF performance requirement after integrating Time Division Duplex (TDD) based 5G NR Integrated Macro gNB with CA of 700 MHz, and with Crest Factor Reduction (CFR) and DPD modules in Digital Front End line-up. In some embodiments, the proposed base station (302) may be configured to combine an application layer, a Medium Access Control (MAC) layer, and a baseband layer based on the one or more network processors (304), the one or more transceivers (306), and the RFEB (404) that include RF high power amplifier(s), low noise amplifier(s) (LNAs), and RF switches, and the cavity filter (406). In such embodiments, the base station (302) may be configured in a convection cooled passive enclosure having weight of less than about 18 Kgs.

The present disclosure, therefore, relates to a 5G Integrated Macro gNB with CA of 700 MHz that provides an “All-in-one” unit having one or more baseband units, RF units, and antenna units in single closure for easy and efficient installation. The proposed 5G NR Integrated Macro gNB with CA of 700 MHz may have a power of at least up to about 200 W that operates in macro class (typically 50 W or 47 dBm per antenna port) with 4T4R configuration, and complements macro-level wide-area solutions requiring good coverage and limited capacity, and have reduced latencies and is particularly beneficial in Rural and Sub-Urban areas, compared to existing solutions. In the present disclosure, a Centralized Unit (CU) associated with the base station (302) may be introduced for 3.5 GHz and 700 MHz both on a 10G backhaul, thereby saving on costs and reducing OPEX. In another exemplary aspect, the proposed solution further provides for CA of 700 MHz low band RUs, and eliminates the need of Distributed Units (DUs) below the tower.

In an exemplary aspect, the proposed solution may provide peak data rates of 1.5 GB/s at 100 MHz channel bandwidth in 3.5 GHz spectrum. The 5G NR Integrated Macro gNB (302) with CA of 700 MHz solutions may be suited for next generation Radio Access Networks (RANs) for providing 5G network services in sub urban and rural areas. The proposed solution may reduce cost and improve power efficiency, thus enabling a wide range of 5G use cases. The integrated Macro gNB (302) with CA of 700 MHz may provide wide area coverage in distributed population to meet the traffic demand and may guarantee an apt user experience in data download rates for in a plurality of UE. The proposed solutions expand access to 5G network services.

Typically, exemplary telecom networks may comprise a RAN and a core network (e.g., shown as an evolved packet core (EPC)) coupled together through an interface. In a non-limiting example, the RAN may be an evolved universal terrestrial radio access network (E-UTRAN). In another non-limiting example, the RAN may include one or more components of a New Radio (NR) network. In another non-limiting example, the RAN may include one or more components of an E-UTRAN and one or more components of another network (including but not limited to an NR network).

In some embodiments, the network may include (and/or support) one or more gNBs. In some embodiments, one or more eNBs may be configured to operate as gNBs. Embodiments are not limited to the number of evolved Node Bs (eNBs) or to the number of gNBs. In some embodiments, the network may not necessarily include eNBs.

It should be noted that references herein to an eNB or to a gNB are not limiting. In some embodiments, one or more operations, methods and/or techniques (such as those described herein) may be practiced by a base station component (and/or other component), including but not limited to a gNB, an eNB, a serving cell, a transmit receive point (TRP) and/or other. In some embodiments, the base station component may be configured to operate in accordance with the NR protocol and/or NR standard, although the scope of embodiments is not limited in this respect. In some embodiments, the base station component may be configured to operate in accordance with a Fifth Generation (5G) protocol and/or 5G standard, although the scope of embodiments is not limited in this respect.

In some embodiments, one or more of the UEs may be configured to operate in accordance with an NR protocol and/or NR techniques. For instance, descriptions of one or more operations, techniques, and/or methods practiced by a gNB are not limiting.

In some embodiments, the UEs may transmit signals (data, control, or the like) to the gNB, and may receive signals (data, control, or the like) from the gNB. In some embodiments, UE may transmit signals (data, control, or the like) to the eNB, and may receive signals (data, control, or the like) from the eNB.

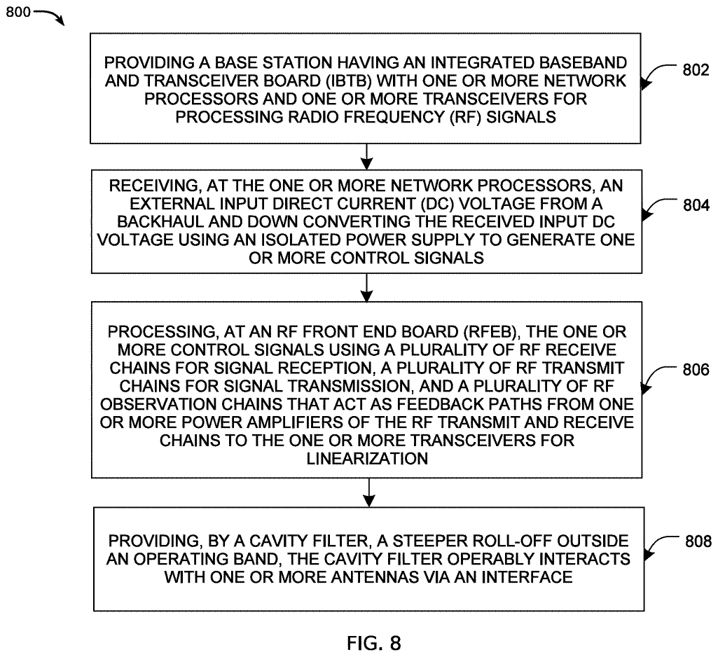

FIG. 8 illustrates an exemplary flowchart (800) for operating a base station, in accordance with embodiments of the present disclosure.

At step (802), the method (800) may include providing a base station, such as the base station (302) of FIGS. 2-7, having an integrated baseband and transceiver board (IBTB) with one or more network processors and one or more transceivers for processing Radio Frequency (RF) signals.

At step (804), the method (800) may include receiving, at the one or more network processors, an external input direct current (DC) voltage from a backhaul and down converting the received input DC voltage using an isolated power supply to generate one or more control signals. In some embodiments, the input DC voltage may be provided by one or more antennas that receive one or more Radio Frequency (RF) signals from one or more User Equipment (UEs).

At step (806), the method (800) may include receiving and processing, at an RF front end board (RFEB), the one or more control signals using a plurality of RF receive chains for signal reception, a plurality of RF transmit chains for signal transmission, and a plurality of RF observation chains that act as feedback paths from one or more power amplifiers of the RF transmit and receive chains to the one or more transceivers for linearization.

At step (808), the method (800) may include providing, by a cavity filter, a steeper roll-off outside operating band, the cavity filter operably interacts with one or more antennas via an interface.

In an aspect, for processing RF signals, the method (800) may include performing, by the one or more network processors, Layer 2 and Layer 3 processing of sub 6 GHz and 700 MHz bands. The method (800) may include performing, by the one or more transceivers, Layer 1 processing of sub 6 GHz bands, and processing, by the one or more transceivers, Physical (PHY) layer of 700 MHz bands.

In an aspect, when the received external input DC voltage 48V, the method (800) may include down-converting the external input DC voltage to 28V and 12V simultaneously.

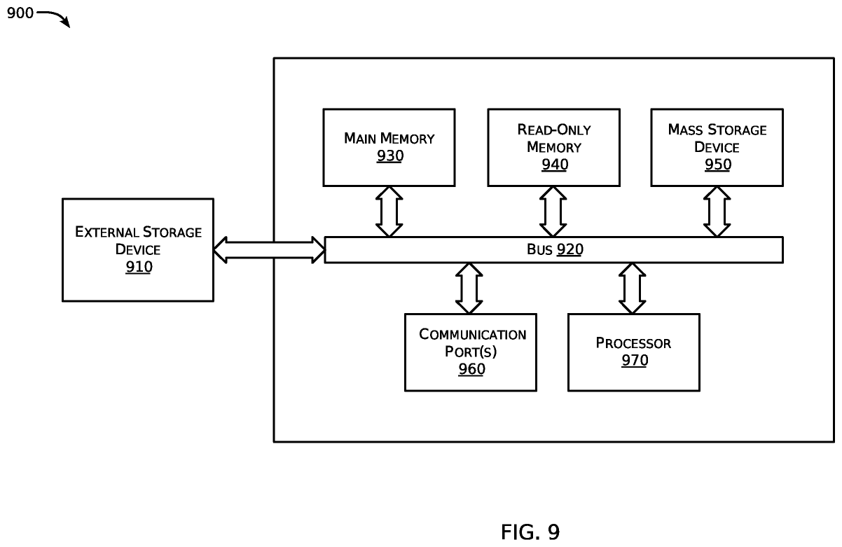

FIG. 9 illustrates an exemplary computer system (900) in which or with which embodiments of the present disclosure may be utilized.

As shown in FIG. 9, computer system (900) may include an external storage device (910), a bus (920), a main memory (930), a read only memory (940), a mass storage device (950), communication port (960), and a processor (970). A person skilled in the art will appreciate that the computer system (900) may include more than one processor and communication ports. The processor (970) may include various modules associated with embodiments of the present disclosure. The communication port (960) may be chosen depending on a network, such a Local Area Network (LAN), Wide Area Network (WAN), or any network to which computer system connects. The memory (930) may be a Random Access Memory (RAM), or any other dynamic storage device commonly known in the art. The read-only memory (940) may be any static storage device(s). The mass storage (950) may be any current or future mass storage solution, which may be used to store information and/or instructions.

The bus (920) communicatively couples the processor (970) with the other memory, storage and communication blocks. Optionally, operator and administrative interfaces, e.g., a display, keyboard, and a cursor control device, may also be coupled to the bus (920) to support direct operator interaction with the computer system (900). Other operator and administrative interfaces may be provided through network connections connected through the communication port (960). Components described above are meant only to exemplify various possibilities. In no way should the aforementioned exemplary computer system (900) limit the scope of the present disclosure.

In some embodiments, a non-transitory computer-readable medium includes processor-executable instructions that cause a processor to perform the methods as discussed herein.

While considerable emphasis has been placed herein on the preferred embodiments, it will be appreciated that many embodiments may be made and that many changes may be made in the preferred embodiments without departing from the scope of the present disclosure. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### ADVANTAGES OF THE PRESENT DISCLOSURE

The present disclosure provides solutions and devices that are beneficial to provide coverage and capacity as per Massive multiple-input multiple-output (MIMO) Radio Unit (MRU).

The present disclosure provides a hybrid solution for Rural and Sub-Urban areas to meet the coverage and limited capacity requirements.

The present disclosure provides a device/solution that provides cost and energy efficient solution to any network leading to operational expenditure (OPEX) benefits.

The present disclosure provides a device/solution where carrier aggregation and Open Radio Access Network (ORAN) functionality may be merged in the 3.5 Ghz radio (macro unit)may.

The present disclosure provides a 5G Integrated Macro Next-Generation Node B (gNB) with Carrier Aggregation (CA) of 700 MHz bands that provides an overall hardware overview of Macro gNB design for standalone mode, and is configured as an “All-in-one” unit having at least one of a baseband unit, a Radio Frequency (RF) unit, and an antenna unit in a single enclosure for easy and efficient installation.

The present disclosure provides a 5G Integrated Macro gNB with CA 700 MHz carrier aggregation on ORAN based fronthaul interface that eliminates requirement for Centralized Unit (CU) and Distributed Unit (DU).

The present disclosure provides a 5G Integrated Macro gNB that enables direct connection of about 700 Radio Units (RUs) to Macro gNB over ORAN interface, and named as Integrated Macro gNB with CA of 700 MHz.

The present disclosure provides a 5G Integrated Macro gNB with CA of 700 MHz that renders an “All-in-one” class design having a Physical (PHY) layer, a Medium Access Control (MAC) layer, and an Application layer along with complete mechanical housing in one box.

The present disclosure provides an overall integrated system having a network processor and one or more transceivers on a board with 22 or more layers.

The present disclosure provides a multilayer substrate for high power amplifier to accommodate complex RF and digital signal routing in RF Front End Board

The present disclosure provides clock synchronization architecture using system synchronizer Integrated Circuit (IC) and clock generators.

The present disclosure facilitates L1 layer development and bit stream generation in Application Specific Integrated Circuit (ASIC) Transceiver, and enable blind mated and cable less design.

The present disclosure facilitates power efficiency with overall power consumption of about 714 W to significantly improve OPEX.

The present disclosure provides a unique power supply design of converting external input of 48V to 28V, and 28V further to 12V using isolated design with 22 or more layers having high speed and RF design.

The present disclosure provides a unique circuit design implementation to maintain uniform RF output across specified temperature range.

The present disclosure provides a design approach to self-heal the system from software corruption and any other unwanted failure from software faults to help minimize on-site visit of an engineer and thereby save OPEX.

The present disclosure provides a unique baseband board design for thermal efficient system.

The present disclosure provides closed loop monitoring and control of output RF power on each antenna port based on ambient temperature.

The present disclosure provides a base station that handles holdover requirement defined in telecom standards.

We claim:

1. A base station (302), comprising:
an integrated baseband and transceiver board (IBTB) (402) having one or more network processors (304), and one or more transceivers (306) for processing Radio Frequency (RF) signals, wherein the IBTB (402), at the one or more network processors (304), receives, from a backhaul, an external input direct current (DC) voltage and down converts said received input DC voltage using an isolated power supply to generate one or more control signals;
an RF front end board (RFEB) (404) that receives the one or more control signals, and processes said one or more control signals using a plurality of RF receive chains for signal reception, a plurality of RF transmit chains for signal transmission, and a plurality of RF observation chains that act as feedback paths from one or more power amplifiers (704) of the RF transmit and receive chains to the one or more transceivers (306) for linearization;
a cavity filter (406) to provide steeper roll-off outside operating band; and
an interface for operating one or more antennas.

2. The base station (302) as claimed in claim 1, wherein the one or more network processors (304) perform Layer 2 and Layer 3 processing of sub 6 GHz and 700 MHz bands.

3. The base station (302) as claimed in claim 1, wherein the one or more transceivers (306) comprise a first transceiver (306-1) and a second transceiver (306-2), and wherein the first transceiver (306-1) performs Layer 1 processing of sub 6 GHz bands and the second transceiver (306-2) performs processing of Physical (PHY) layer of 700 MHz bands.

4. The base station (302) as claimed in claim 1, wherein the base station (302) is a 5G integrated macro Next Generation Node B (gNB) that merges carrier aggregation (CA) and Open Radio Access Network (ORAN) functionality in a radio unit (RU), said merger allowing handling of capacity and coverage of a Massive MIMO Radio Unit (MRU).

5. The base station (302) as claimed in claim 4, wherein the base station (302) provides CA for 700 MHz bands on ORAN based fronthaul interface.

6. The base station (302) as claimed in claim 1, wherein the received external input DC voltage is 48V, which is down converted to 12V.

7. The base station (302) as claimed in claim 1, wherein the IBTB (402) comprises a power management integrated chipset (PMIC) (506), a DC-DC converter (504), and a Low Drop Out (LDO) regulator (502) to generate voltages based on requirements of components forming part of the IBTB (402).

8. The base station (302) as claimed in claim 1, wherein the IBTB (402) comprises at least one temperature sensor to evaluate a thermal profile of the RFEB (404) and facilitate taking of a decision in case of a thermal failure.

9. The base station (302) as claimed in claim 1, wherein the one or more transceivers (306) monitor an output of the one or more power amplifiers (704) by measuring received power on an Analog-to-Digital Converter (ADC) while utilizing a feedback chain, said measured power being utilized for monitoring total transmit power in closed loop.

10. The base station (302) as claimed in claim 1, comprising a synchronization circuit (510) for synchronization of components in the IBTB (402), wherein the clock and synchronization circuit (510) comprises at least one of: an ultra-low noise clock generation Phase-Locked Loop (PLLs) (604), programmable oscillator, and a system synchronizer (602).

11. The base station (302) as claimed in claim 1, wherein the IBTB (402) comprises a plurality of sub-systems selected from any or a combination of: a digital high speed signal sub-system, a switching power supply sub-system, and a clock section, and an RF signal sub-system.

12. The base station (302) as claimed in claim 1, wherein the IBTB (402) is configured as a Printed Circuit Board (PCB) with 22 or more layers, said PCB design comprising a mechanism to route RF signals and Peripheral Component Interconnect Express (PCIe) signals running on adjacent layers.

13. The base station (302) as claimed in claim 1, wherein the RFEB (404) receives the one or more control signals from the IBTB (402) along with a power supply through a connector, wherein 4 transmit chains are configured for signal transmission, 4 receive chains are configured for signal reception, and 4 observation chains are configured to act as Digital Pre-Distortion (DPD) feedback paths from the one or more power amplifiers (704) to an Application Specific Integrated Circuit (ASIC) transceiver from the one or more transceivers (306) for linearization.

14. The base station (302) as claimed in claim 1, wherein each transmit chain carries matching Balun, Pre-Driver amplifier (702), and final RF power amplifier as final stage power amplifiers, and wherein each receive chain carries low noise amplifier band pass one or more Surface Acoustic Wave (SAW) filters and a matching network.

15. The base station (302) as claimed in claim 1, wherein each observation chain carries a directional coupler, one or more digital step attenuators (DSAs), and a matching network, and wherein the RFEB (404) comprises a RF switch that combines each transmit-receive pair.

16. The base station (302) as claimed in claim 1, wherein a circulator and the cavity filter (406) are used between each RF switch to an antenna port.

17. The base station (302) as claimed in claim 1, wherein the RFEB (404) blind mates with the IBTB (402) and the cavity filter (406), and wherein one or more mating bullets provide connection between the IBTB (402) and the RFEB (404) to facilitate provision of at least up to 200W output.

18. The base station (302) as claimed in claim 1, wherein the cavity filter (406) is a 4-port cavity filter for providing a 4-transmit-4-receive (4T4R) configuration.

19. A method (800) for operating a base station, the method (800) comprising:
providing a base station having an integrated baseband and transceiver board (IBTB) with one or more network processors and one or more transceivers for processing Radio Frequency (RF) signals;
receiving, at the one or more network processors, an external input direct current (DC) voltage from a backhaul and down converting the received input DC voltage using an isolated power supply to generate one or more control signals;
processing, at an RF front end board (RFEB), the one or more control signals using a plurality of RF receive chains for signal reception, a plurality of RF transmit chains for signal transmission, and a plurality of RF observation chains that act as feedback paths from one or more power amplifiers of the RF transmit and receive chains to the one or more transceivers for linearization; and
providing, by a cavity filter, a steeper roll-off outside operating band, the cavity filter operably interacts with one or more antennas via an interface.

20. The method (800) as claimed in claim 19, wherein for processing RF signals, the method (800) comprises:
performing, by the one or more network processors, Layer 2 and Layer 3 processing of sub 6 GHz and 700 MHz bands;
performing, by the one or more transceivers, Layer 1 processing of sub 6 GHZ bands; and
processing, by the one or more transceivers, Physical (PHY) layer of 700 MHz bands.

21. A user equipment communicatively coupled to a base station (302), said coupling comprises steps of:
receiving a connection request;
sending an acknowledgement of the connection request to the base station (302); and
transmitting a plurality of signals in response to the connection request, wherein the base station (302) is as claimed in claim 1.

22. A non-transitory computer-readable medium comprising processor-executable instructions that cause a processor to:
provide a base station having an integrated baseband and transceiver board (IBTB) with one or more network processors and one or more transceivers for processing Radio Frequency (RF) signals;
receive, at the one or more network processors, an external input direct current (DC) voltage from a backhaul and down convert the received input DC voltage using an isolated power supply to generate one or more control signals;
process, at an RF front end board (RFEB), the one or more control signals using a plurality of RF receive chains for signal reception, a plurality of RF transmit chains for signal transmission, and a plurality of RF observation chains that act as feedback paths from one or more power amplifiers of the RF transmit and receive chains to the one or more transceivers for linearization; and
provide, by a cavity filter, a steeper roll-off outside operating band, the cavity filter operably interacts with one or more antennas via an interface.
